(19) United States
(12) Patent Application Publication
(10) Pub. No.: US 2013/0186809 A1
(43) Pub. Date: Jul. 25, 2013

(54) CLARIFIER AND LAUNDER SYSTEMS

(71) Applicant: John L. FEATHERSTONE, El Centro, CA (US)

(72) Inventor: John L. FEATHERSTONE, El Centro, CA (US)

(21) Appl. No.: 13/733,425

(22) Filed: Jan. 3, 2013

Related U.S. Application Data
(60) Provisional application No. 61/588,840, filed on Jan. 20, 2012.

(51) Int. Cl. B01D 21/00

(52) U.S. Cl. CPC B01D 21/0069
USPC 210/97; 210/521

(57) ABSTRACT

A clarifier system that comprises a clarifier and a launder system. The launder system comprises a plurality of radial launders and a peripheral launder. The launder system and the clarifier may be alloyed with an anti-corrosive material to reduce corrosion and scaling and enable use of the clarifier system for longer operating runs between overhauls. In addition, the launder system is configured to facilitate easy on-line cleaning, thereby minimizing down time of the clarifier system.

### CROSS-REFERENCE TO RELATED APPLICATIONS

This application claims benefit and priority to U.S. Provisional Application No. 61/588,840 filed Jan. 20, 2012, the disclosure of which is incorporated by reference herein in its entirety.

### BACKGROUND OF THE DISCLOSURE

1.0 Field of the Invention

The present disclosure relates to clarifier and launder systems having increased resistance to corrosion and scaling, among other features.

2.0 Related Art

Geothermal energy has been used to produce electricity since the early 1900's, and today there are hundreds of geothermal power plants operating worldwide with an aggregate capacity of nearly 10,000 MW. In the United States alone, 84 geothermal power plants operate with an aggregate nameplate capacity of approximately 3,000 MW. For example, ten geothermal plants with a combined capacity of 327 MW were built between 1982 and 2000 in the Salton Sea KGRA, and all are still operating, having shown no significant signs of depletion. The Salton Sea geothermal resource has an estimated generation capacity ranging between 1,200 MW and 1,400 MW.

Geothermal energy can be produced in areas having a geothermal system. A geothermal system is made up of three main elements comprising: (i) a heat source which often consists of a magmatic intrusion that has reached a relatively shallow depth of 5-10 km; (ii) a reservoir consisting of a volume of hot permeable rocks from which the circulating fluids extract heat; and (iii) a geothermal fluid consisting of water or brine in liquid or vaporous phase. The reservoir is generally overlain by a cover of impermeable rocks and connected to a surface recharge area through which meteoric waters can replace or partly replace the fluids that escape or are extracted. The system is primarily driven by fluid convection in which heated fluid of lower density tends to rise and be replaced by colder fluid of high density coming from the margins of the system or from an injection well.

The quantity and quality of a geothermal resource is affected by a number of factors, including the size of the reservoir, the temperature of the geothermal fluids in the reservoir (measured as enthalpy), the pressure of the reservoir, the depth and capacity of the production and injection wells, the amount of total dissolved solids (“TDS”) and non-condensable gases (“NCG”) contained in such geothermal fluids, and the permeability of the subsurface rock formations containing such geothermal resource, including the presence, extent and location of fractures in such rocks.

The Salton Sea KGRA, which is located in Southern California, is regarded by many as one of the most prolific geothermal resources in North America. The Salton Sea geothermal reservoir occurs in fractured sedimentary rocks within the Salton Trough, a structural depression on the boundary between two tectonic plates. The thermal anomaly of the Salton Sea field appears to be centered on a major fault zone that acts as a conduit for hot geothermal brines upwelling from large depths beneath the surface.

The sedimentary nature of the reservoir rock at the Salton Sea results in much more predictable bedding than in other geothermal fields (such as those in volcanic or granitic rocks). As a result, rates of drilling success within the Salton Sea area are very high and the fractured, porous sandstones yield very productive wells. The thick layers of fractured sediments also provide unusually strong pressure support from surrounding ground water aquifers, as compared to other geothermal fields (such as The Geysers in northern California) where pressure support is more limited. Reservoir temperatures beneath the Salton Sea are among the hottest of any geothermal field in the world, with measured values in excess of 700° F.

Geothermal energy is typically produced by one of three different types of power plants consisting of dry steam power plants, binary plants and flash power plants. The choice of plant technology depends primarily on the nature and enthalpy of the geothermal fluid inside the reservoir. In dry steam power plants, steam is released directly at the surface where it is processed and sent through a steam turbine which runs a generator to produce electricity. Dry steam systems are used for high temperature (over 350° F.) vapor-dominated systems.

In binary plants, hot geothermal brine flows are brought to the surface through a process similar to flash plants and are then passed through heat exchangers, boiling an organic fluid that spins a turbine. Binary systems are used for lower temperature (from 220° F. to 350° F.) geothermal systems. The condensed steam and remaining geothermal fluid from all three types of plants are injected back into the earth via injection wells to continue the sustainability of the process.

In flash power plants, which are used for high temperature systems (over 350° F.) with water-dominated geothermal fluid (e.g., geothermal brines) such as the system in the Salton Sea, hot pressurized geothermal fluids are extracted from a geothermal reservoir by production wells and ‘flashed’ into steam in pressure vessels after which the resulting steam is processed and sent through a steam turbine. Any geothermal brine that is not converted into steam is then disposed of.

Geothermal brines are not usually comprised of saline alone but instead contain many dissolved minerals and gases. Among the contaminants that may be found in geothermal brines are hydrogen sulfide, carbon dioxide, ammonia, silica, lead, iron, arsenic and cadmium compounds. The dissolved minerals and gases within geothermal brines are highly corrosive to the processing equipment employed in flash power plants. Moreover, the geothermal brine that is not converted into steam (i.e., geothermal effluent) containing mineral and elemental constituents such as lead and arsenic, cannot be acceptably discharged into the surrounding environment. Accordingly, most geothermal effluent is disposed of by pumping it back into the ground through injection wells.

Injection of the geothermal effluent safely disposes of dissolved materials and is useful in preventing ground subsidence, which might otherwise be caused by depletion of the subterranean aquifers from which the geothermal brine is initially extracted. Suspended solids in geothermal effluent, however, cannot be easily injected back into the earth because such solids clog the injection wells. Clarifiers are therefore employed to remove suspended solids from geothermal effluent so that the effluent can be injected back into the ground. Clarifiers provide an agglomeration zone for coalescing particles with one another. Any fine solid particulates remaining after processing in the clarifier can be removed by filtration before the geothermal effluent is injected back into the earth.

Existing clarifiers, which employ pipes slotted either on the top or on the bottom, tend to suffer from severe carbon steel corrosion and scaling problems in the liquid vapor portions including in the launder areas. The liquid vapor portion is typically between the brine (liquid) and the steam vapor region. These problems can cause premature shutdowns, earlier than planned plant outages, and expensive welding repair for leaks.

The launders in existing clarifiers tend to have a rectangular trough shape and are typically attached to the interior of the perimeter wall of the clarifier. It is not uncommon for these launders to become completely plugged even after only six months of operation. When the launders plug with material such as geothermal scale, it is very difficult (and sometimes impossible) to clean them while still operating the geothermal power plant system (i.e., while the system is still “on-line”).

An unfulfilled need, therefore, exists for providing clarifiers and launders that are resistant to corrosion and scaling problems. A need also exists for clarifiers and launders that may be easily cleaned/maintained while the system is on-line and in operation.

### SUMMARY OF THE DISCLOSURE

Accordingly, the present disclosure provides clarifier and launder systems having increased resistance to corrosion and scaling. The clarifier and launder systems of the instant disclosure are also configured in a manner that easily allows for cleaning and maintenance to be done while the geothermal power plant system is on-line. Use of the clarifier and launder systems of the instant disclosure is advantageous because the systems enable longer operating runs between overhauls, reduced operating costs, and on-line maintenance of the geothermal power plant systems in which they are employed.

One aspect of the disclosure relates to a clarifier system that may comprise a clarifier defined by a perimeter wall having a top, a bottom, an interior and an exterior and a floor that is connected to the bottom of the perimeter wall. The clarifier system also comprises a peripheral launder extending around the exterior of the perimeter wall; and a plurality of radial launders, wherein each of the plurality of radial launders has a first end and a second end, wherein the second end protrudes from the interior to the exterior of the perimeter wall.

The interior of the perimeter wall of the clarifier is generally smooth and unobstructed, except where each of the plurality of radial launders protrude through the wall to be connected to the peripheral launder. According to an aspect of the disclosure, the liquid vapor regions of the clarifier may be alloyed with a material that is resistant to corrosion (e.g., 2205 duplex stainless steel). This may result in a clarifier system exhibiting corrosion that is greatly reduced as compared to current clarifiers.

The peripheral launder may be in the form of a pipe and may comprise a plurality of launder sections. Each of the launder sections may comprise one or more launder cleanout ports to provide accessibility to the peripheral launder for cleaning and maintenance purposes. The cleanout ports are hydroblast ports. In addition, the peripheral launder may be alloyed with a material that is resistant to corrosion (e.g., 2205 duplex steel).

Each of the plurality of radial launders may be joined to the peripheral launder on the exterior of the perimeter wall and may be in the form of a pipe to facilitate on-line cleaning and maintenance. The plurality of radial launders may include more than one length or may be of uniform length. In one aspect of the disclosure, 16 radial launders are employed in the clarifier system and the radial launders alternate between one or more short and one or more long lengths to facilitate good distribution of clarified brine exiting the clarifier. The second end of each of the radial launders may be down-cut at an angle and may further comprise a radial launder cleanout. Each of the radial launders may also be alloyed with a material that is resistant to corrosion (e.g., 2205 duplex stainless steel), thereby enabling long-term operation. The peripheral and radial launders have a configuration that facilitates easy on-line cleaning, thereby minimizing down time of the clarifier system.

Yet another aspect of the disclosure relates to a launder system that may comprise a peripheral launder; and a plurality of radial launders according to the disclosure, wherein each of the plurality of radial launders has a first end and a second end, and is joined to the peripheral launder.

Additional features, advantages, and embodiments of the disclosure may be set forth or apparent from consideration of the detailed description and drawings. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a geothermal power plant system, according to an aspect of the disclosure;

FIG. 2 depicts a top view of a clarifier system that includes a launder system that is constructed according to the principles of the disclosure; and

FIG. 3 shows a side view of the clarifier and launder systems of FIG. 2.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

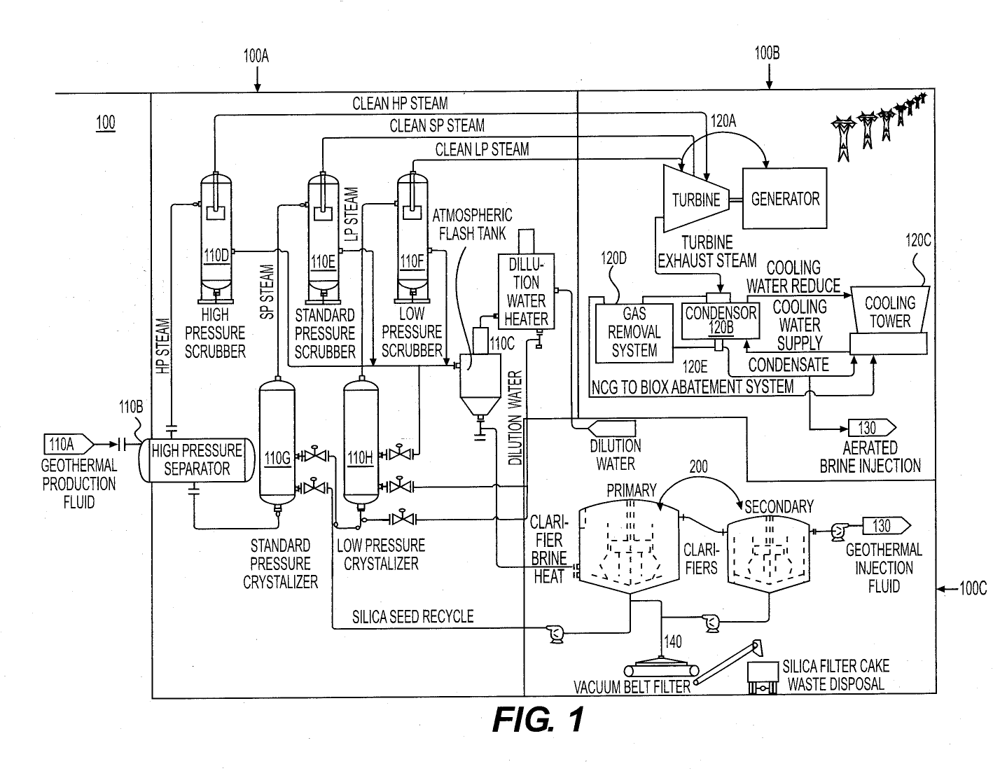

FIG. 1 shows an example of a geothermal power generating (GPG) facility 100. The GPG facility 100 may comprise a brine processing facility (BPF) 100A and a turbine generator (TG) facility 100B. The BPF 100A may comprise one or more geothermal production wells 110A, a brine and steam handling facility (which may comprise flash tanks 110C, scrubbers 110D, 110E and 110F, vent tanks (not shown) and associated equipment), a solids handling system 100C (which may comprise clarifiers 200, thickeners (not shown) and associated equipment), a brine pond (not shown), a fresh water pond (not shown), and one or more injection wells 130. The GPG facility 100 may also comprise a distributed control system (not shown), which may include a computer. The distributed control system may further include a database. The computer and/or database may be connected to a network via one or more communication links.

The geothermal production wells 110A may be configured to deliver, for example, about 3,830,965 pounds per hour (“lbs/hr”) of geothermal brine at a temperature of, for example, about 563° F. to the GPG facility 100 through an above-ground pipeline (not shown), which may be used to interconnect the production wells 110A with the brine processing facility 100A. Furthermore, the GPG facility 100 may also be configured to produce, for example, 49.9 MW net (e.g., 55 MW gross capacity), 60 MW net, 90 MW net, or more of geothermal power over an extended period of time (e.g., 5 years, 10 years, 20 years, 30 years, or the like).

Geothermal brine is piped from a production well 110A into a high pressure separator 110B and then flows to the GPG facility 100. The geothermal brine may be passed through a triple-flash geothermal cycle to produce electricity. In the triple-flash geothermal cycle, the geothermal brine may be successively flashed at a high pressure, standard pressure and low pressure to produce high-pressure (HP), standard-pressure (SP) and low-pressure (LP) steam. Equipment such as flash vessels 110C, crystallizers 110G and 110H, and associated equipment may be used to effectively flash the high salinity brine.

After flashing the geothermal brine, the resulting HP, SP and LP steam may be sent to the turbine generator (TG) facility 100B while the brine that is not converted to steam is further processed in the solids handling system 100C to remove solids before being reinjected into the reservoir through injection wells 130. Prior to reinjection, a portion of the brine steam may also be diverted to a facility located on the property adjacent to the GPG facility 100, where both minerals and silica are extracted.

The TG facility 100B may include, e.g., a 55 MW (gross) geothermal steam turbine generator 120A, a heat rejection system (i.e., condenser 120B and cooling tower 120C), a gas removal and emission abatement system 120D and 120E, respectively, a control building (not shown), a warehouse (not shown), a service water pond (not shown) and other ancillary facilities, including, e.g., a 230 kV switchyard and several power distribution centers (not shown). Primary control of the TG facility 100B may be routed through a fully integrated digital control system (e.g., computer) (not shown), which may be incorporated into the GPG facility's 100 distributed control system.

The TG facility 100B may intake steam from the BPF 100A at three entry pressures, HP, SP, and LP and at each pressure level the steam may be directed through steam scrubbers 110D, 110E and 110F and de-misters (not shown) prior to entry into the TG facility 100B. These steam scrubbers 110D, 110E and 110F may be designed to produce, e.g., about 99.95% quality steam by removing free liquids and a proportion of the entrained liquids within the steam. Approximately 447,000 lbs/hr of HP steam at, e.g., about 423° F. and about 305 psig, 160,000 lbs/hr of SP steam at, e.g., about 343° F. and about 109 psig, and 218,000 lbs/hr of LP steam at, e.g., about 249° F. and about 14 psig may be delivered to the TG facility 100B. The steam may then be sent to the turbine generator system 120A, which may include, e.g., a 55 MW (gross) condensing steam turbine (ST) equipped with HP, SP and LP inlets (not shown). In FIG. 1, HP is high pressure; SP is standard pressure; LP is low pressure; and NCG is non-condensable gas.

The ST may be directly coupled to an enclosed water and air-cooled synchronous-type generator (STG). The STG may include three-phase turbine-generator unit 120A, with an output voltage of, e.g., about 13.8 kV, a power output of, e.g., about 64.71 MVA (megavolt amperes), and a power factor of, e.g., about 0.85 operating at 60 Hertz. The turbine-generator unit 120A may be fully equipped with all the necessary auxiliary systems for turbine control and speed protection, lubricating oil, gland sealing, generator excitation, and cooling, as well as a spare turbine rotor and a full package of spare parts.

Steam from the STG may be condensed in a two-pass shell constructed of carbon steel and a tube condenser constructed of stainless steel. Condensate or cooling water may be transferred from the condenser 120B to an induced-draft cooling tower 120C, cooled and returned to the condenser 120B by, e.g., two 50% capacity, circulating water pumps (with one additional 50% capacity circulating pump and motor included with the initial spares). Make-up water for the cycle may be supplied from the condensate that comes from the STG condenser and also from local a water supply, the latter primarily during the summer months. Gases that accumulate in the condenser 120B may be evacuated by a non-condensable gases (“NCG”) removal system 120E.

The NCG removal system 120E may be pressurized and vented to a hydrogen sulfide abatement system (not shown). The hydrogen sulfide abatement system (not shown) may be used to control the hydrogen sulfide emissions from both the vent gases and the geothermal steam condensate, employing a Biox process. The Biox system may include an oxidizing biocide in contact with the cooling tower 120C circulating water to convert dissolved hydrogen sulfide to water-soluble sulfates. Biocide assisted oxidation may be utilized to control primary hydrogen sulfide vent gas emissions by bubbling the vent gas into the cooling tower catch basin (not shown). This process may substantially reduce secondary emissions of hydrogen sulfide from the cooling towers 120C when utilizing steam condensate for makeup water. The Biox system may remove a minimum of, e.g., about 95% of the hydrogen sulfide in the non-condensable vent gases and a minimum of, e.g., about 98% of the hydrogen sulfide in the portion of the condensate used as cooling tower makeup water.

Plant auxiliary power may be provided from the STG during normal plant operations in the GPG facility 100, and by, e.g., two 50% 4.16 kV and one 480 volt (“V”) emergency diesel generators during a plant shutdown. Additionally, back-up power to the plant can be provided by the IID transmission system (not shown). The auxiliary power system may include, e.g., two 4.16 kV switchgear line-ups and three 480 V motor control centers to provide power for turbine 120A, cooling tower 120C, circulating/service water pumps (not shown), resource production load (not shown), and injection/booster pump controls (not shown). A 480 V emergency generator (not shown), for example, may be made available to provide backup for plant control power. The diesel generators (not shown), which may operate less than, e.g., 600 hours per year, may meet certain state regulatory requirements (e.g., California Air Resources Board (“CARB”) source emission limits).

Electrical power produced by the STG may be connected to, e.g., a 230 kV substation via a generator breaker, a 600 Ampere disconnect switch, and a generator step-up transformer, which steps-up the voltage from, e.g., about 13.8 kV to about 230 kV in the facility switchyard. Power may be delivered from the GPG facility 100 to the IID (not shown) at the point of interconnection (POI), which may be defined to be, e.g., the 230 kV transmission line disconnect switch at the substation.

The substation may interconnect to the substation in the IID transmission network via, e.g., two new 230 kV transmission line segments, which may include, e.g., one 3.5-mile 230 kV transmission line segment that extends from an H-frame at the substation to a geographic intersection located some distance from the substation, and another transmission line segment that extends, e.g., about 8.5 miles from the transmission interconnection to the substation in the IID transmission network. This substation may be connected to one or more other substations.

During the flashing process brine from the high pressure separator is routed to a standard pressure (SP) crystallizer 110G and a low pressure (LP) crystallizer 110H in series to facilitate processes such as precipitating silica in the brine at SP and LP steam conditions (e.g., about 115 psig and about 18 psig, respectively).

The stabilized brine from the crystallizers 110G and 110H may then flow into the solids handling system 100C (which may comprise a clarifier system 200, filter and associated equipment) where solids may be removed. The stabilized brine may be initially sent to an atmospheric flash tank 110C that reduces remaining pressure to atmospheric pressure, which may then be further processed via primary and secondary clarifier systems 200 wherein solids are concentrated and then passed through a horizontal vacuum belt filter 140, treated with acid and neutralizing washes, and steam and hot-air dried to produce a silica rich filter cake. The filter cake may be either primarily recycled for beneficial use, or it may be transported off-site for disposal.

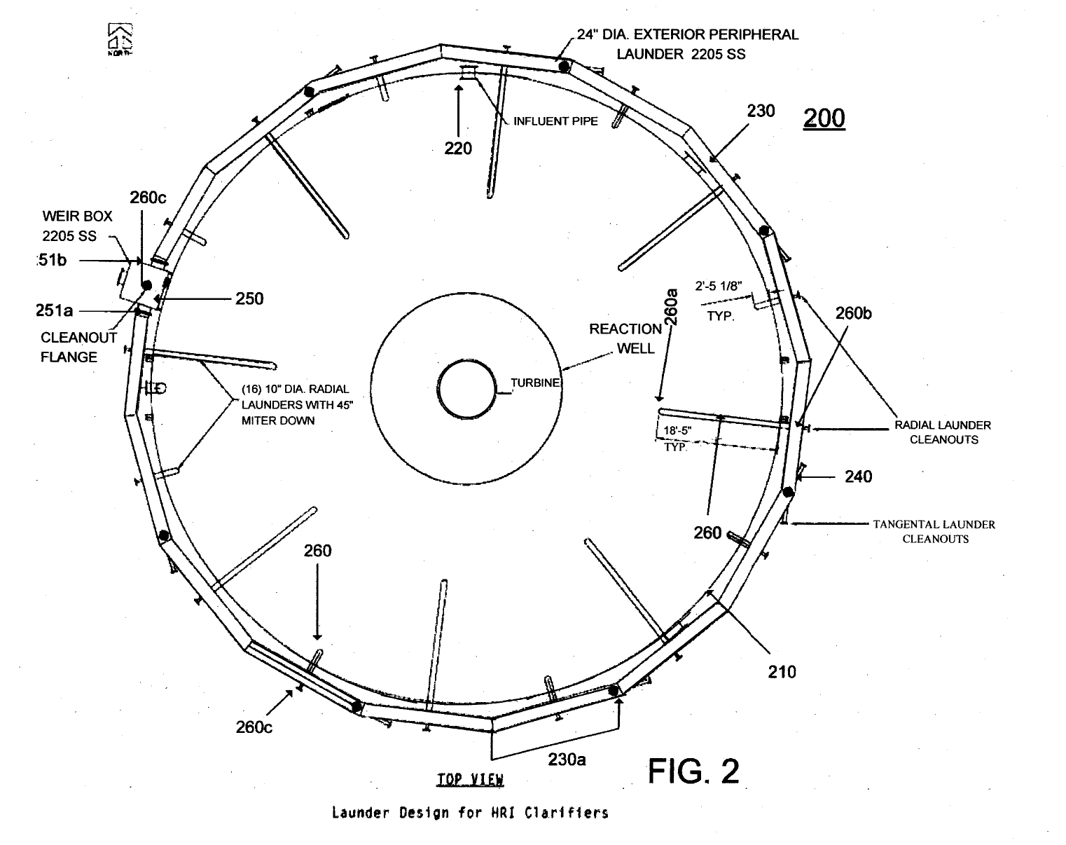

FIG. 2 shows a top view of a clarifier system 200 that may be used in the solids handling system to remove solids from stabilized brine in the GPG facility 100. Clarifier systems, such as the system shown in FIG. 2, are designed to separate most of the solid particles or materials from a liquid. Usually, solids and liquids are added to the clarifier system, such as the system shown in FIG. 2, and are combined into a slurry. The majority of solids will then settle to the bottom of the clarifier system 200, and the liquid, which may still contain some solids, will rise to the top of the clarifier system 200 where it is collected by one or more launders. The separation occurs in accordance with Stokes law.

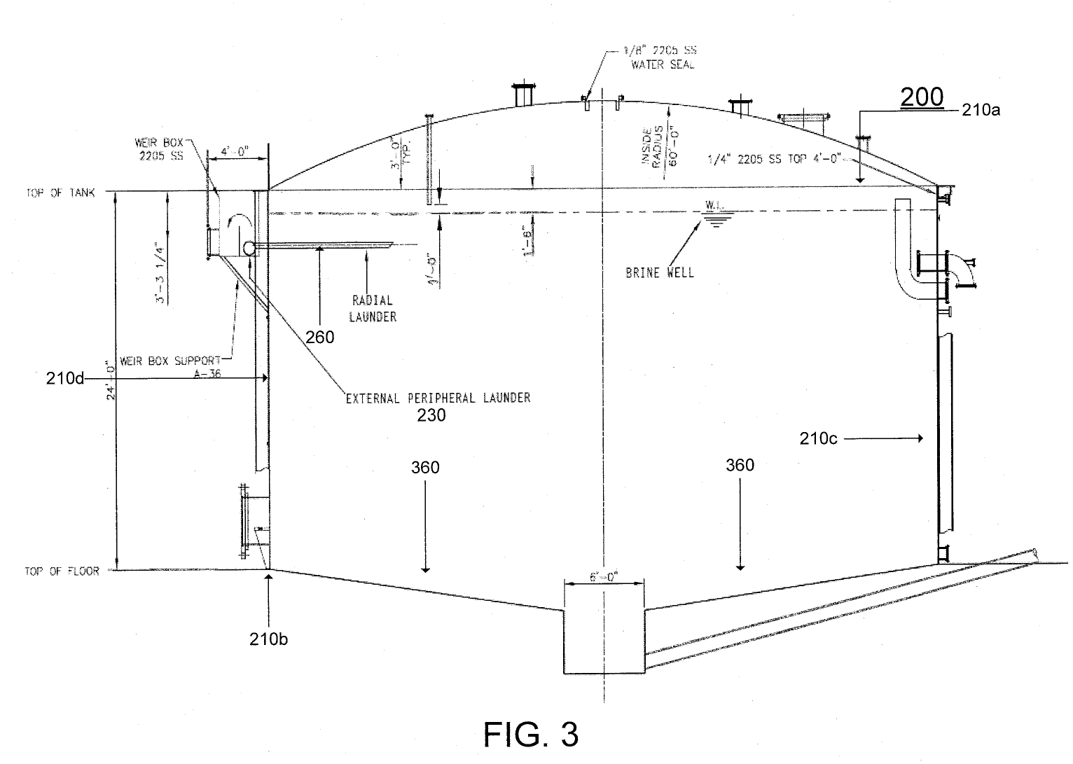

The clarifier system 200 is typically defined by a perimeter wall 210 and a floor 360 (shown in FIG. 3). The perimeter wall 210 may be rectangular, circular, or any other desired shape and has a top 210a (shown in FIG. 3), a bottom 210b (shown in FIG. 3), an interior 210c (shown in FIG. 3) and an exterior 210d (shown in FIG. 3). Most typically, the perimeter wall 210 is circular so that the perimeter wall 210 and floor 360 form a cylindrical tank. The perimeter wall 210 may comprise an inlet 220 through which solids and liquids enter the clarifier system 200. In addition, the floor 360 (shown in FIG. 3) may comprise an exit (not shown) through which solids may leave after being separated from liquids in the clarifier system 200. Solids may be accumulated on the floor 360 (shown in FIG. 3), and guided into the exit, using gravity, rake arms or scrapers (not shown). The clarified liquid typically flows over the top 210a of the perimeter wall 210 of the clarifier system 200. The steel side sections of the clarifier below the alloyed upper section of the clarifiers may be coated with a high temperature epoxy paint to prevent corrosion of carbon steel parts.

Typically, a peripheral launder 230 extends around the exterior 210d of the perimeter wall 210. More typically, the peripheral launder 230 extends around the exterior 210d of the top 210a of the perimeter wall 210. The peripheral launder 230 may be in the form of a pipe. The peripheral launder 230 may comprise one or more ports 240 which are easy to access from the exterior of the clarifier system 200. Each of the ports 240 is usually located in a tangential position to the peripheral launder 230 but the ports 240 may be positioned in any manner that facilitates easy on-line cleaning of the peripheral launder 230. In one aspect of the disclosure, the peripheral launder 230 may comprise a plurality of launder sections 230a, wherein each of the launder sections 230a comprises a port 240. The port 240 may be located in a position that is tangential to the peripheral launder 230.

A weir box 250 may be integrated into the peripheral launder 230. The weir box 250 comprises openings 251a and 251b at each end such that liquid flowing through the peripheral launder 230 may enter one end (i.e., 251a or 251b) of the weir box 250 and flow back into the peripheral launder 230 through the other end (i.e., 251b or 251a) of the weir box 250. In addition, the weir box 250 may comprise a cleanout flange 250c. The weir box 250 functions to maintain a constant level of liquid within the clarifier system 200 regardless of what the flow rate is of liquids and solids into the inlet of the clarifier system 200. Duplex stainless steels may be chosen for Salton Sea geothermal brines because their ferritic/austenitic crystal structure resists various types of corrosion to a higher degree than the pure martensitic, ferritic, and austenitic grades of stainless steels. The weir box is typically constructed of 2205 duplex stainless steel. Higher alloyed materials could be used as well as high temperature epoxy coated carbon steel.

The peripheral launder 230 may be alloyed with an anti-corrosive material to prevent it from suffering from corrosion and scaling problems. The anti-corrosive material may be any Salton Sea Geothermal brine corrosion resistant material, typically 2205 duplex stainless steel. Higher alloyed duplex stainless steels such as alloy 2507 may be used. Alternately, the peripheral launder 230 may be lined or coated with a high temperature epoxy material.

The clarifier system 200 may comprise a plurality of radial launders 260, wherein each of the radial launders 260 comprises a first end 260a and a second end 260b. The radial launders are typically in the form of a pipe, wherein the second end 260b protrudes from the interior 210c of the perimeter wall through to the exterior 210d of the perimeter wall 210. The second end 260b of each radial launder 260 also usually protrudes through the peripheral launder 230 and is joined to the peripheral launder 230 on the exterior 210d of the perimeter wall 210. The second end 260b of each of the radial launders 260 may also comprise a launder cleanout port 260c to facilitate cleaning of the radial launder 260. The cleanout ports 260c may comprise hydroblast ports. The radial launders 260 may be straight sections of pipe. Near the end of each section, a flange valve may be located in line with the section. Maintenance personnel can mount to the valve with a hydroblast tool (jet) while the clarifier is in operation. The valve may be opened and the hydroblast jet is pushed into the section of pipe to clean the section of any scale. The exact length of the short and long radial launders will depend on the area diameter of the clarifier.

The plurality of radial launders 260 may include, e.g., two varying lengths, as seen in FIG. 2, such as, about 2′⅛″ and about 18′5″. When the plurality of radial launders 260 include varying lengths, a radial launder 260 of a shorter length is typically positioned adjacent to a radial launder 260 of a longer length to facilitate good distribution of clarified brine exiting the clarifier system 200. In an alternative aspect of the disclosure, the plurality of radial launders 260 have substantially the same length, or have three or more different lengths. Furthermore, each of the plurality of radial launders may be formed from pipe having a diameter of about 10″ with a 45° miter down-cut end. Each of the radial launders 260 may have smaller or larger diameters. The cut-angle at one end of each radial launder 260 may be greater than, or less than, 45°. In addition, each of the radial launders 260 may have substantially the same cut-angle as an adjacent radial launder 260, or a different cut-angle than an adjacent radial launder 260.

Each of the radial launders 260 may be alloyed with a brine-resistant anti-corrosive material to prevent it from suffering from corrosion and scaling problems. The anti-corrosive material may be any anti-corrosive material. Most often, each of the radial launders 260 is alloyed with 2205 duplex stainless steel. Alternately, high temperature epoxy lined or coated carbon steel may be used. Moreover, the anti-corrosive material may be selected from the group consisting of: 2205 duplex stainless steel, may be selected from a group consisting of: 2205 duplex stainless steel, higher alloyed duplex stainless steels (e.g., alloy 2507), high performance nickel rich alloys (e.g., alloy 825), any of the nickel-chromium-molybdenum alloys (e.g., Inconel 625 and Hastelloy C-276), and various Titanium alloys (e.g., Ti grade 12).

FIG. 3 shows a cross-sectional side view of the clarifier system 200 of the present disclosure. As can be seen in FIG. 3, the interior 210c of the perimeter wall 210 is generally smooth and unobstructed except for where devices such as the radial launders 260 protrude through to be connected to the peripheral launder 230.

Furthermore, in one aspect of the disclosure, either the entire interior 210c of the perimeter wall 210, or a part of the interior 210c of the perimeter wall 210, may be alloyed with an anti-corrosive material to prevent it from suffering from corrosion and/or scaling problems. Typically, any portion of the interior 210c of the perimeter wall 210 that will come into contact with the mixture of liquids and solids inputted into the clarifier system 200 is alloyed with an anti-corrosive material. The anti-corrosive material may be any anti-corrosive material. Higher alloys such as super duplex 2507 may be used. Alternately, high temperature epoxy lined or coated carbon steel may be used. Moreover, the anti-corrosive material may be selected from the group consisting of: 2205 duplex stainless steel, from the group consisting of: 2205 duplex stainless steel, higher alloyed duplex stainless steels (e.g. alloy 2507), high performance nickel rich alloys (e.g., alloy 825), a nickel-chromium-molybdenum alloy (e.g., Inconel 625 and Hastelloy C-276), and a Titanium alloy (e.g., Ti grade 12).

Brine from overflow of the clarifiers 200 and thickeners, condensate from the steam vent tanks and brine from the production wells 110A during start-up may be directed to the brine pond (not shown) for temporary containment. The brine pond (not shown) may include a double-lined basin sized to accommodate, e.g., about four hours of brine flow during normal operating conditions. Fluids from the brine pond (not shown) may be subsequently processed through a clarifier thickener, such as a clarifier system 200 described herein, and delivered to the injection pump system and pumped to the plant injection wells 130 for subsurface injection.

Prior to reinjecting geothermal effluent back into the ground, a portion of the brine stream may also be diverted to a materials facility (not shown), which may be located adjacent to (and remotely from) the GPG facility 100, where both minerals and silica may be extracted. The materials facility may include a multi-booster (e.g., two or more booster) and multi-main injection pumps (e.g., two or more injection pumps) that may be connected in series, which may pump the spent brine from the secondary clarifier to the injection wells 130 via pipelines such as above-ground pipelines for subsurface injection. The injection pipeline system may include one or more cement-lined carbon steel injection pipes, or may include a combination of alloy (e.g., 2205) and cement-lined carbon steel injection pipes. Each injection well 130 may be remotely monitored for pressure, temperature and flow rate. Corrosion issues in the plant piping system may be minimized or eliminated through the use of certain metal alloys and other material that have proven to be corrosion resistant. The resulting cleaner brine may then be returned to the GPG facility 100, mixed with the back-end brine stream, and injected into the well field.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A clarifier system comprising:
a clarifier defined by a perimeter wall having a top, a bottom, an interior and an exterior, and a floor that is connected to the bottom of the perimeter wall;
a peripheral launder extending around the top of the perimeter wall; and
a plurality of radial launders, wherein each of the plurality of radial launders has a first end and a second end, wherein the second end protrudes from the interior to the exterior of the perimeter wall and through the peripheral launder.

2. The clarifier system of claim 1, wherein all, or a portion, of the interior of the perimeter wall is alloyed with an anti-corrosive material.

3. The clarifier system of claim 2, wherein the anti-corrosive material is selected from the group consisting of: 2205 duplex stainless steel, from the group consisting of: 2205 duplex stainless steel, a higher alloyed duplex stainless steel, a high performance nickel rich alloy, a nickel-chromium-molybdenum alloy, and a Titanium alloy.

4. The clarifier system of claim 1, further comprising a plurality of ports extending from the peripheral launder.

5. The clarifier system of claim 4, wherein each of the plurality of ports is tangential to the peripheral launder.

6. The clarifier system of claim 1, wherein the peripheral launder further comprises a weir box.

7. The clarifier system of claim 6, wherein the weir box comprises a cleanout flange.

8. The clarifier system of claim 1, wherein each of the radial launders is joined to the peripheral launder on the exterior of the perimeter wall.

9. A clarifier system comprising:
a clarifier defined by a perimeter wall having a top, a bottom, an interior and an exterior, and a floor that is connected to the bottom of the perimeter wall;
a peripheral launder extending around the top of the perimeter wall; and
a plurality of radial launders, wherein each of the plurality of radial launders has a first end and a second end, wherein the second end protrudes from the interior to the exterior of the perimeter wall and through the peripheral launder,
wherein at least one of the peripheral launder and the plurality of radial launders is alloyed with an anti-corrosive material.

10. The clarifier system of claim 9, wherein all, or a portion, of the interior of the perimeter wall is alloyed with an anti-corrosive material.

11. The clarifier system of claim 9, wherein the anti-corrosive material is selected from the group consisting of: 2205 duplex stainless steel, a higher alloyed duplex stainless steel, a high performance nickel rich alloy, a nickel-chromium-molybdenum alloy, and a Titanium alloy.

12. The clarifier system of claim 9, wherein both the peripheral launder and the plurality of radial launders is alloyed with an anti-corrosive material.

13. The clarifier system of claim 9, wherein the plurality of radial launders comprise radial launders of different lengths.

14. The clarifier system of claim 13, wherein the second end of each of the radial launders is down-cut at an angle of about 45°.

15. The clarifier system of claim 13, wherein the second end of each of the radial launders further comprises a radial launder cleanout.

16. The clarifier system of claim 13, wherein each of the radial launders is alloyed with an anti-corrosive material selected from the group consisting of: 2205 duplex stainless steel, a higher alloyed duplex stainless steel, a high performance nickel rich alloy, a nickel-chromium-molybdenum alloy, and a Titanium alloy.

17. The clarifier system of claim 9, wherein the plurality of radial launders comprise radial launders of uniform length.

18. The clarifier system of claim 17, wherein the second end of each of the radial launders is down-cut at an angle of about 45°.

19. The clarifier system of claim 17, wherein the second end of each of the radial launders further comprises a radial launder cleanout.

20. The clarifier system of claim 17, wherein each of the radial launders is alloyed with an anti-corrosive material selected from the group consisting of: 2205 duplex stainless steel, higher alloyed duplex stainless steel, a high performance nickel rich alloy, a nickel-chromium-molybdenum alloy and a Titanium alloy.
